(19) United States
(12) Patent Application Publication
(10) Pub. No.: US 2016/0318198 A1
(43) Pub. Date: Nov. 3, 2016

(54) Razor Attachment

(71) Applicant: Larry Brazley, Chicago, IL (US)

(72) Inventor: Larry Brazley, Chicago, IL (US)

(21) Appl. No.: 14/877,119

(22) Filed: Oct. 7, 2015

Related U.S. Application Data
(60) Provisional application No. 62/154,837, filed on Apr. 30, 2015.

(51) Int. Cl. B26B 21/40

(52) U.S. Cl. CPC B26B 21/4037

(57) ABSTRACT

A razor attachment that allows a user to trim facial hair to a desired length. The razor attachment has a body that can be removably secured to the upper end of the head of a razor. Depending upon the embodiment, the body may secure directly to the upper end of the head of the razor, or may be secured to the handle of the razor. The body comprises a lip that extends over the blades of a razor so as to create a space between the blades and the user's skin. In this way, the lip helps to allow the user to control the length of hair that will be cut using the razor. The position of the lip relative to the blades is adjustable so that the user can trim his facial hair to a desired length.

### CROSS REFERENCE TO RELATED APPLICATION

This application claims the benefit of U.S. Provisional Application No. 62/154,837 filed on Apr. 30, 2014. The above identified patent application is herein incorporated by reference in its entirety to provide continuity of disclosure.

### BACKGROUND OF THE INVENTION

### Field of the Invention

The present invention relates to razor attachments. More specifically, the present invention provides a razor attachment that allows the user to trim hair to a desired length. The razor attachment can be removably secured to the head of a razor and includes a lip that extends over the blades of the razor so as to separate the blades from the user's skin.

Men often shave their facial hair in order to maintain a clean and neat appearance. However, many men maintain some facial hair to achieve a desired look or appearance. Thus, many men wish to allow some facial hair or stubble to remain in order to provide a more rugged or stylish appearance. Generally, people use various tools such as razors, electric razors, trimmers, and scissors in order to achieve a desired look. However, utilizing multiple tools can be inconvenient and undesirable. Thus, a razor attachment that can be used with a conventional razor in order to allow a user to shave facial hair to a specific length is desired.

Devices have been disclosed in the prior art that relate to shaving and trimming devices. These include devices that have been patented and published in patent application publications. These devices generally relate to combination shaving and trimming devices, such as U.S. Pat. No. 5,084,967, U.S. Published Patent Application Number 2010/0037463, U.S. Pat. No. 5,022,153, U.S. Pat. No. 4,283,848, and U.S. Pat. No. 3,178,815.

These prior art devices have several known drawbacks. The devices in the prior art generally relate to shaving devices that additionally include trimming means. However, many of these devices are not adjustable and thus do not allow the user to trim his facial hair to a desired length. Further, such devices are not suitable for use with a conventional razor, requiring the user to purchase a special razor having a trimming attachment, which can be undesirable and inconvenient.

In light of the devices disclosed in the prior art, it is submitted that the present invention substantially diverges in design elements from the prior art and consequently it is clear that there is a need in the art for an improvement to existing razor attachment devices. In this regard the instant invention substantially fulfills these needs.

### SUMMARY OF THE INVENTION

In view of the foregoing disadvantages inherent in the known types of razor attachments now present in the prior art, the present invention provides a new razor attachment wherein the same can be utilized for providing convenience for the user when shaving facial hair to a desired length.

It is therefore an object of the present invention to provide a new and improved razor attachment having a body that can be removably secured to a razor, wherein a lip extends over the blades of the razor in order to separate the blades from the user's skin.

It is another object of the present invention to provide a razor attachment comprising a body removably securable to the head of the razor.

Another object of the present invention is to provide a razor attachment comprising a body removably securable to the handle of a razor.

Yet another object of the present invention is to provide a razor attachment having a lip that can be adjustably positioned over the blades of a razor.

Another object of the present invention is to provide a razor attachment that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the razor attachment.

FIG. 2 shows a side view of an embodiment of the razor attachment.

FIG. 3 shows a perspective view of an alternate embodiment of the razor attachment.

FIG. 4 shows a side view of an alternate embodiment of the razor attachment.

### DETAILED DESCRIPTION OF THE INVENTION

Reference is made herein to the attached drawings. Like reference numerals are used throughout the drawings to depict like or similar elements of the razor attachment. For the purposes of presenting a brief and clear description of the present invention, the preferred embodiment will be discussed as used for allowing a user to trim facial hair to a desired length. The figures are intended for representative purposes only and should not be considered to be limiting in any respect.

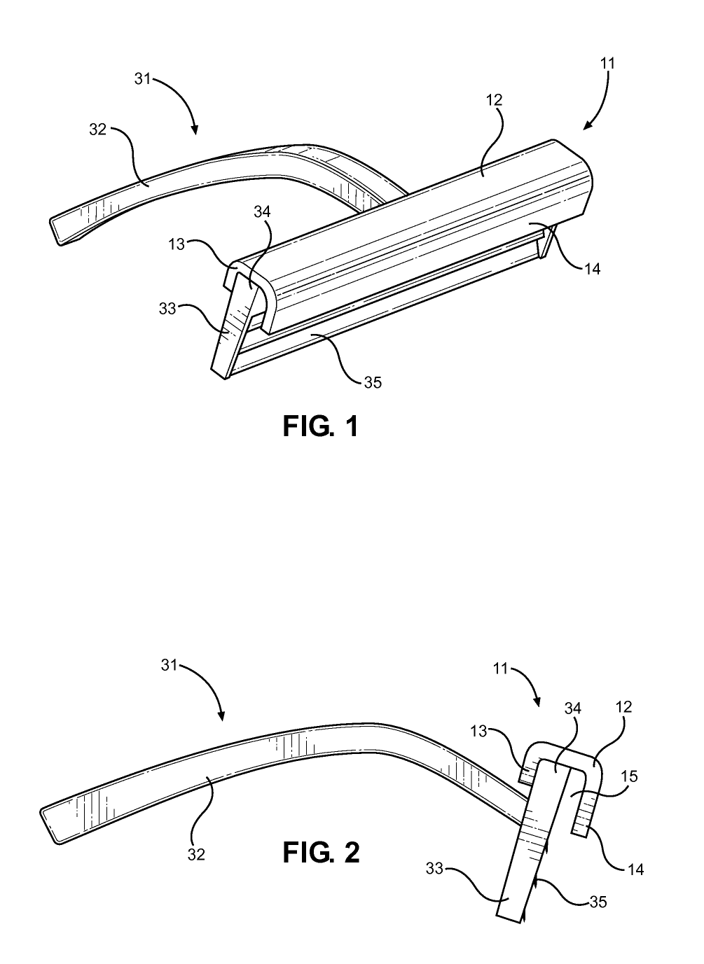

Referring now to FIGS. 1 and 2, there is shown a perspective view and a side view of an embodiment of the razor attachment, respectively. The razor attachment 11 comprises a body 12 that is adapted to be removably secured to the razor 31. The body 12 is of unitary construction and has an arcuate configuration. In the illustrated embodiment, the rear portion of the body 12 is adapted to be secured to the upper end 34 of the head 33 of the razor 31. The rear portion 14 is contoured similarly to the shape of the head 33 of the razor 31 so that it can be frictionally engaged therewith. Thus, the body 12 can be snapped in place over the upper end of the head 33 of the razor 31 in order to removably secure the razor attachment 11 onto the razor 31.

The front portion of the body 12 comprises a lip 14. The lip 14 extends over the blades 35 on the razor and has an arcuate configuration. The lip 14 extends from the upper end of the head 33 of the razor 31 towards the lower end thereof. The lip 14 is separated from the blades 35 by a space 15. The space 15 allows the user to control the length of hair to be trimmed when using the razor 31 in that the lip 14 creates a separation between the blades 35 and the user's skin. Further, the lip 14 preferably extends along the width of the head 33 of the razor 31 such that the width of the lip 14 and the head 33 of the razor 31 are substantially the same. In some embodiments, the lip 14 is pivotally affixed to the body 12 so that the positioning of the lip 14 relative to the blades 35 can be adjusted, so as to allow the user to trim facial hair to a desired length.

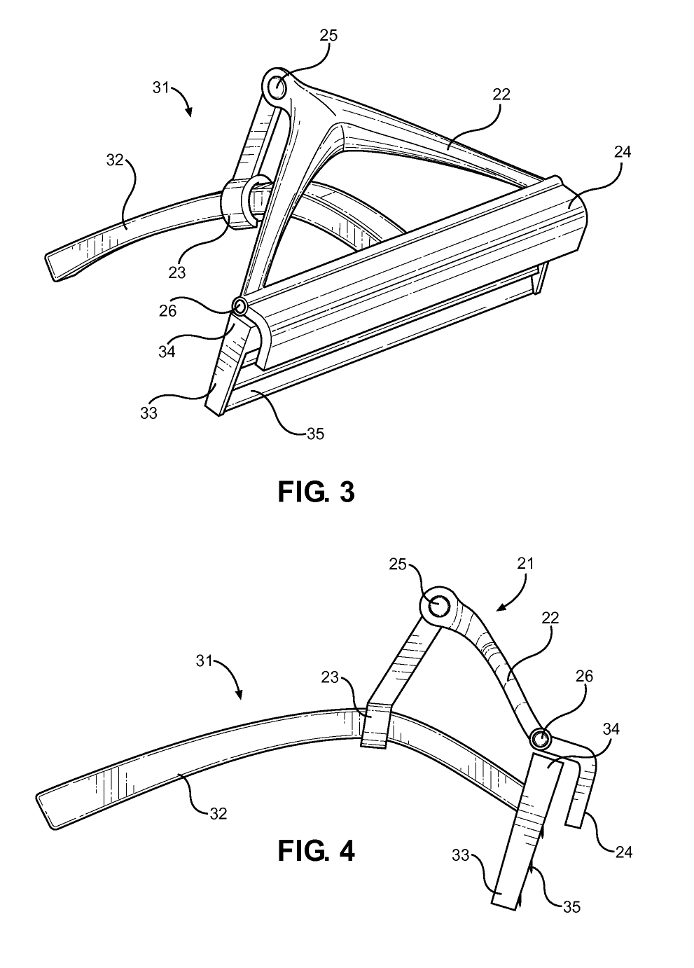

Referring now to FIGS. 3 and 4, there is shown a perspective view and a side view of an alternate embodiment of the razor attachment, respectively. In some embodiments, the razor attachment 21 can be removably secured to the handle 32 of the razor 31. The razor attachment 21 comprises a body 22 having a fastener 23 on a rear portion thereof. The fastener 23 is preferably a cuff that can be secured around the handle 32 so that the fastener 23 encircles the handle. The fastener 23 is pivotally affixed to the body 22 via a hinge 25 that allows the positioning of the body 22 on the razor 31 to be adjusted as necessary.

The front end of the body 22 comprises a lip 24 thereon, wherein the lip 24 extends over the blades 35 on the head 33 of the razor 31. The lip 24 is similar in function and construction as the lip of the embodiment shown in FIGS. 1 and 2. The lip 24 has an arcuate configuration and extends from the upper end of the head 33 of the razor 31 towards the lower end thereof. The lip 24 is separated from the blades 35 via a space so as to allow the user to control the length of hair to be trimmed. The lip 24 is pivotally affixed to the body 22 via a hinge 26 so that the positioning of the lip 24 can be adjusted as desired by the user.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A razor attachment, comprising:
a body adapted to be secured to a razor;
a lip extending from a front portion of said body, wherein said lip extends from an upper portion of a head of said razor towards a lower portion thereof;
wherein said lip is separated from a blade of said head of said razor by a space such that said lip prevents said blade from directly contacting the skin of the user when shaving.

2) The razor attachment of claim 1, wherein said body comprises a rear portion adapted to be secured to said head of said razor.

3) The razor attachment of claim 2, wherein said rear portion is adapted to be secured to said head of said razor via frictional fit.

4) The razor attachment of claim 2, wherein said lip comprises an arcuate configuration.

5) The razor attachment of claim 2, wherein said lip is pivotally affixed to said front portion of said body.

6) The razor attachment of claim 1, wherein said body is removably securable to a handle of said razor.

7) The razor attachment of claim 6, further comprising a fastener that is removably securable to said handle of said razor.

8) The razor attachment of claim 7, wherein said fastener is pivotally secured to said body.

9) The razor attachment of claim 6, wherein said lip comprises an arcuate configuration.

10) The razor attachment of claim 6, wherein said lip is pivotally affixed to said body.
